(19) United States
(12) Patent Application Publication
(10) Pub. No.: US 2024/0361809 A1
(43) Pub. Date: Oct. 31, 2024

(54) ELECTRONIC DEVICE WITH A LAMINATE COMPONENT

(71) Applicant: Apple Inc., Cupertino, CA (US)

(72) Inventors: Drake W. Stacy, Austin, TX (US); Raisul Haque, San Jose, CA (US); Shravan Bharadwaj, San Jose, CA (US); Jessica M. Polkinghorm, San Jose, CA (US); Matthew S. Theobald, San Francisco, CA (US)

(21) Appl. No.: 18/605,764

(22) Filed: Mar. 14, 2024

Related U.S. Application Data
(60) Provisional application No. 63/461,831, filed on Apr. 25, 2023.

(51) Int. Cl. G06F 1/16

(52) U.S. Cl. CPC G06F 1/1656; G06F 1/1643; G06F 1/1698

(57) ABSTRACT

Laminate components for electronic devices are disclosed. The electronic device may include a housing having a laminate structure. The laminate structure may include a first layer defining a front surface of the housing, a second layer defining a rear surface of the housing, and at least one intermediate layer positioned between the first layer and the second layer. The layers of the laminate may be configured to allow another component to be embedded in the housing, to provide an attachment feature, or to provide a reinforcing feature.

### CROSS-REFERENCE TO RELATED APPLICATION(S)

This application is a nonprovisional application of and claims the benefit of U.S. Provisional Patent Application No. 63/461,831, filed Apr. 25, 2023, and titled “Electronic Device with a Laminate Component,” the disclosure of which is hereby incorporated herein by reference in its entirety.

### FIELD

The described embodiments relate generally to electronic devices. More particularly, the present embodiments relate to electronic devices that include a laminate component, such as a laminated enclosure component.

### BACKGROUND

Some conventional consumer electronic devices include an enclosure that surrounds one or more internal electronic components of the device. For example, some conventional enclosures include a metal or plastic housing and a cover that defines a transparent window for a display. In some cases, the electronic device may be provided in a portable form factor.

### SUMMARY

Aspects of the following disclosure relate to electronic device enclosures and electronic devices including these enclosures. The electronic device enclosure may include a housing having a laminate structure. In some examples, all of the housing is constructed from multiple layers while in other examples, only a portion of the housing is constructed from multiple layers.

Forming all or part of the housing from multiple layers may provide a simpler method to form some housing architectures as compared to standard machining methods. As an example, the layers may be assembled to form a cavity within the body of the housing, thus allowing integration of an active or a passive device component within the housing. As another example, the layers may be assembled to form a stepped structure along an interior surface of the housing. The stepped structure may be used to form features such as an attachment feature or a feature used to structurally reinforce the enclosure. As yet another example, the layers may be assembled so that some of the layers preferentially define an exterior surface of the housing. Forming all or part of the housing from multiple layers may also allow tailored variation of the composition of the housing.

The housing may be formed of any of a variety of layers. As examples, the layers used to form the housing may be one or more of metal layers, glass layers, ceramic layers or polymer layers. As another example, the layers used to form the housing may be composite layers. As a specific example, the composite layers may include fibers or particles in a polymer matrix. Suitable materials for the fibers or particles include, but are not limited to, a glass, a ceramic, carbon (e.g., graphite), a metal, a polymer, and combinations of these. The composition of the layers may be tailored to provide desired mechanical, thermal, electrical, or other properties to the housing.

In some embodiments, the housing may be formed of layers having a similar composition, while in other embodiments, the layers used to form the housing may differ in composition. In some cases, each layer may have a substantially uniform composition, but at least one of the layers differs in composition from another layer. For example, all the layers may be metal layers, but at least one of the metal layers may have a different composition than another metal layer. As another example, the set of layers may include multiple metal layers and at least one layer formed of a material other than a metal. As a specific example, or more layers formed from a dielectric material (alternately, dielectric layers) may be interposed between metal layers to form a radio frequency (RF) transmissive window for an RF component within the enclosure. In other cases, a given layer may vary in composition in order to modify a property of the layer as compared to a layer of uniform composition.

In additional aspects of the disclosure, device components other than housings may have a laminated structure. For example, another component of the enclosure, such as a cover member, may have a laminated structure. As an additional example, a component within an internal cavity of the enclosure may be formed from multiple layers to achieve a particular architecture and/or tailored composition in a similar fashion as previously described.

The disclosure provides an electronic device comprising an enclosure comprising a housing, a cover member coupled to the housing and defining a transparent window, a touch-sensitive display positioned below the cover member and within a cavity defined at least in part by the housing and the cover member, and electronic circuitry positioned within the cavity, at least a portion of the housing having a laminate structure comprising a first layer defining a front surface and a first portion of an exterior side surface of the housing, a second layer defining a rear surface and a second portion of the exterior side surface of the housing, and at least one intermediate layer positioned between the first layer and the second layer and defining a third portion of the exterior side surface of the housing.

The disclosure also provides an electronic device comprising electronic circuitry, a display assembly, and an enclosure at least partially surrounding the electronic circuitry and the display assembly and comprising a housing formed at least in part from a set of layers that define an exterior side surface of the housing, the set of layers comprising a first layer defining a front surface of the housing, a second layer defining a rear surface of the housing, and a set of intermediate layers positioned at least partially between the first layer and the second layer, the enclosure further comprising a cover member at least partially defining a front surface of the electronic device, positioned over the display assembly, and coupled to the housing.

In addition, the disclosure provides an electronic device comprising a first portion comprising a first enclosure defining an internal cavity and a transparent window and a display positioned within the first enclosure and below the transparent window and comprising a second portion rotatably coupled to the first portion, defining an input surface, and comprising a second enclosure defining an exterior side surface and a rear surface of the electronic device and a touch sensor positioned within the second enclosure and configured to detect a touch along the input surface, the second enclosure comprising a housing, a front cover member coupled to the housing and defining a front surface of the second enclosure, and a rear cover member coupled to the housing and defining a rear surface of the second enclosure, the housing comprising a first metal layer defining a first portion of the exterior side surface, a second metal layer defining a second portion of the exterior side surface, and at least one intermediate layer positioned between and coupled to the first metal layer and the second metal layer and defining a third portion of the exterior side surface.

### BRIEF DESCRIPTION OF THE DRAWINGS

The disclosure will be readily understood by the following detailed description in conjunction with the accompanying drawings, wherein like reference numerals designate like elements.

FIG. 1A shows an example electronic device.

FIG. 1B shows a simplified exploded view of the electronic device of FIG. 1A.

FIG. 2A shows an example of a partial cross-sectional view of a laminate housing that defines a cavity for another component of an electronic device.

FIG. 2B shows an example of a partial cross-sectional view of a laminate housing that defines an attachment feature.

FIG. 2C shows an example of a cross-sectional view of another laminate housing.

FIGS. 2D and 2E show other example partial cross-sectional views of laminate housings.

FIG. 2F shows an example of a layer of a laminate housing.

FIGS. 3A, 3B, 3C, 3D, 3E, and 3F show other examples of partial cross-sectional views of attachment features formed in laminate structures.

FIG. 4A shows another example of a housing of an electronic device.

FIG. 4B shows an example of a partial cross-sectional view of the housing of FIG. 4A.

FIG. 5A shows another example of a housing of an electronic device.

FIGS. 5B and 5C show examples of partial cross-sectional views of the housing of FIG. 5A.

FIG. 6 shows another example electronic device.

FIG. 7 shows a simplified example of an exploded view of the electronic device of FIG. 6.

FIG. 8 shows another simplified example of an exploded view of the electronic device of FIG. 6.

FIG. 9 shows an example of a partial cross-sectional view of a laminate structure.

FIGS. 10A, 10B, 10C, and 10D show additional examples of partial cross-sectional views of a laminate structure.

FIG. 11A shows another example of a partial cross-sectional view of a laminate structure.

FIG. 11B shows another example of a partial cross-sectional view of a laminate structure.

FIGS. 12A, 12B, and 12C show additional examples of partial cross-sectional views of a of a laminate structure.

FIG. 13 shows another example of a partial cross-sectional view of a laminate structure.

FIG. 14 shows a block diagram of an example electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

Aspects of the following disclosure relate to electronic device enclosures and electronic devices including these enclosures. The electronic device enclosure may include a housing having a laminate structure. In some examples, the laminate structure of the housing includes a first layer defining a front surface of the housing, a second layer defining a rear surface of the housing, and one or more intermediate layers at least partially positioned between the first layer and the second layer. The set of layers may define a side surface of the housing. In some examples, all of the housing is constructed from multiple layers while in other examples, only a portion of the housing is constructed from multiple layers.

Forming all or part of the housing from multiple layers may provide a simpler method to form some housing architectures as compared to standard machining methods. As an example, the layers may be assembled to form a cavity within the body of the housing, thus allowing integration of an active or a passive device component within the housing. As another example, the layers may be assembled to form a laminate structure in which one layer protrudes with respect at least one other layer of the assembly, which may form a stepped structure along an interior surface of the housing. This laminate structure may be used to form features such as an attachment feature or a feature used to structurally reinforce the enclosure. As yet another example, the layers may be assembled so that one or more of the layers preferentially define an exterior surface of the housing. Forming all or part of the housing from multiple layers may also allow tailored variation of the composition of the housing.

The housing may be formed of any of a variety of layers. As examples, the layers used to form the housing may be one or more of metal layers, glass layers, ceramic layers or polymer layers. In some cases, the metal layers may be formed using a stamping technique and/or a laser cutting technique. As another example, the layers used to form the housing may be composite layers. As a specific example, the composite layers may include fibers or particles in a polymer matrix. Suitable materials for the fibers or particles include, but are not limited to, a glass, a ceramic, carbon (e.g., graphite), a metal, a polymer, and combinations of these. The composition of the layers may be tailored to provide desired mechanical, thermal, electrical, magnetic, or other properties to the housing. In some aspects, the composition of the layers may be tailored to obtain a desired appearance, such as a uniform color or a multicolor effect at an exterior surface of the laminate, in combination with the desired mechanical, thermal, electrical, or magnetic properties.

In some embodiments, the housing may be formed of layers having a similar composition, while in other embodiments, the layers used to form the housing may differ in composition. In some cases, each layer may have a substantially uniform composition, but at least one of the layers differs in composition from another layer. As an example, all the layers may be metal layers, but at least one of the metal layers may have a different composition than another metal layer. In some cases, the layers may include at least one layer of an aluminum alloy and at least one layer of a titanium alloy. As examples, a laminate may have aluminum alloy layers defining front and rear surfaces of the housing and one or more intermediate layers formed of a titanium alloy or may have titanium alloy layers defining front and rear surface of the housing and one or more layers formed of an aluminum alloy. As another example, the set of layers may include multiple metal layers and at least one layer formed of a material other than a metal. For example, or more dielectric layers may be interposed between metal layers to form a radio frequency (RF) transmissive window for an RF component within the enclosure.

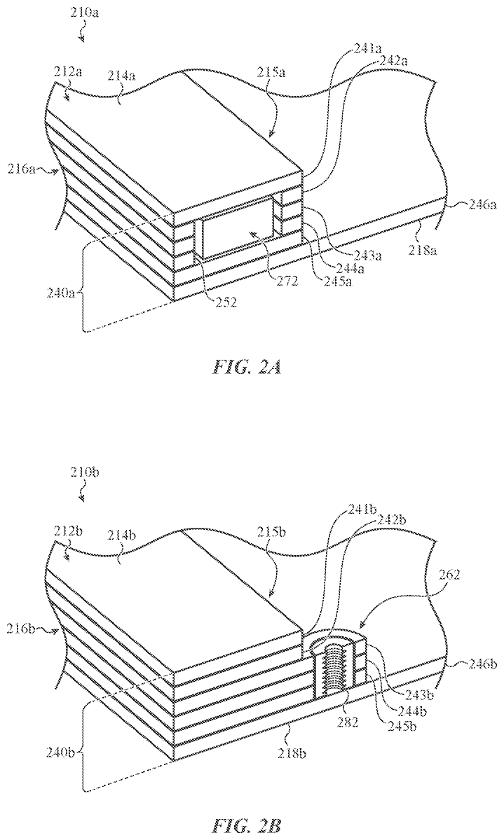

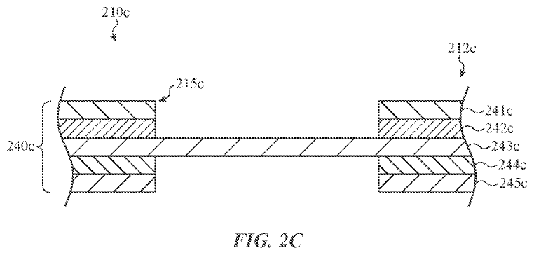

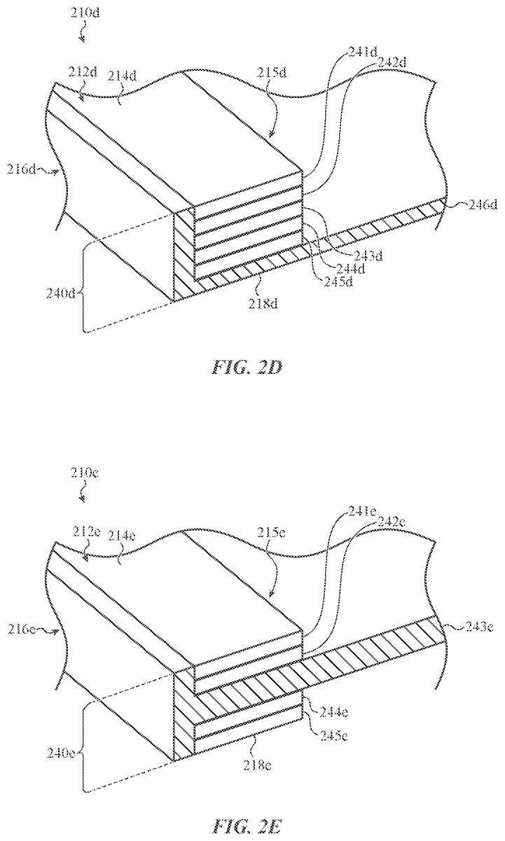

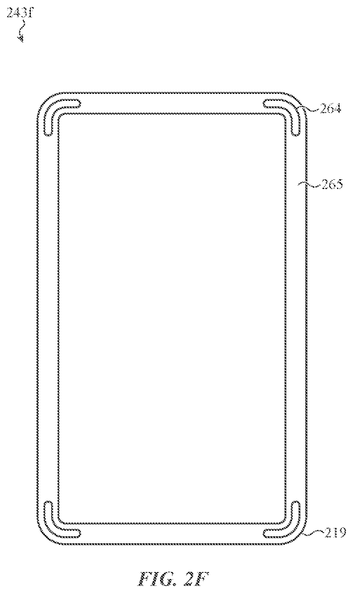

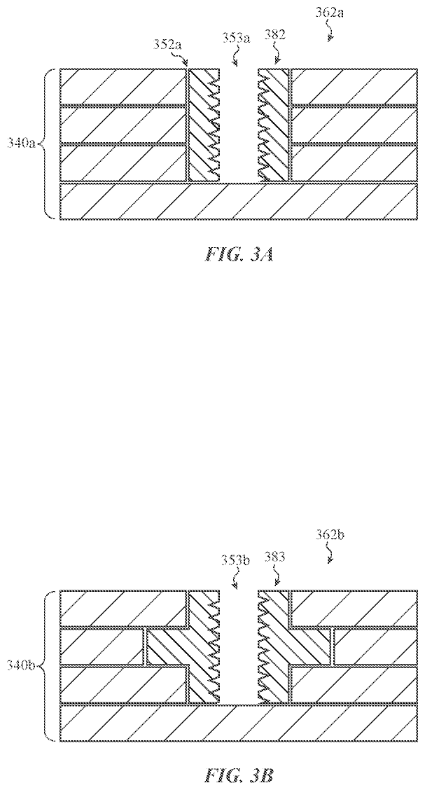

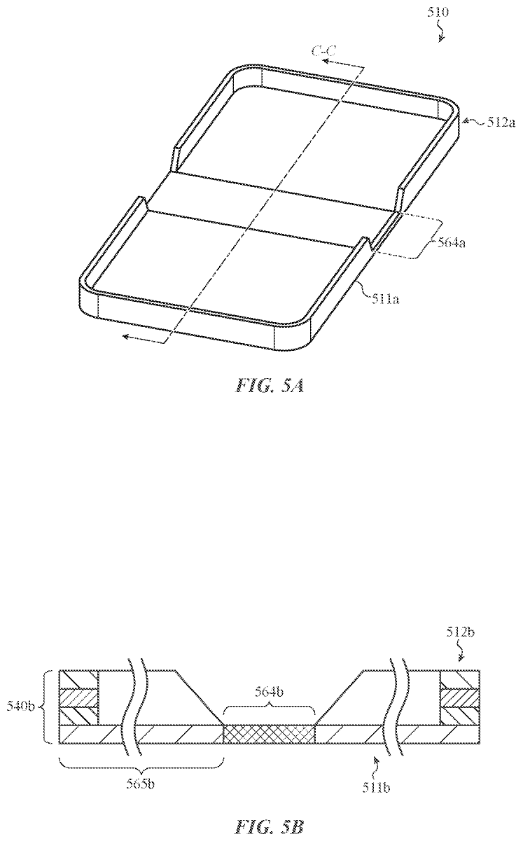

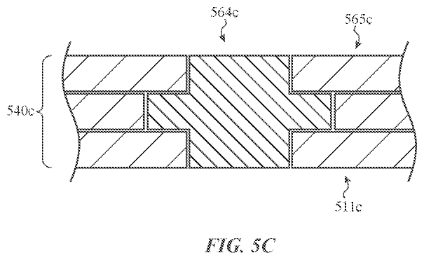

In some cases, a given layer may vary in composition. For example, a second region of the layer may be formed of a different material than a first region in order to modify a property of the layer as compared to a layer formed solely from the material of the first region. The additional description of layers having varying composition provided with respect to FIGS. 2F and 5A-5C is generally applicable herein and is not repeated here.

In additional aspects of the disclosure, device components other than housings may have a laminated structure. For example, another component of the enclosure, such as a cover member, may have a laminated structure. As an additional example, a component within an internal cavity of the enclosure may be formed from multiple layers to achieve a particular architecture and/or tailored composition in a similar fashion as previously described.

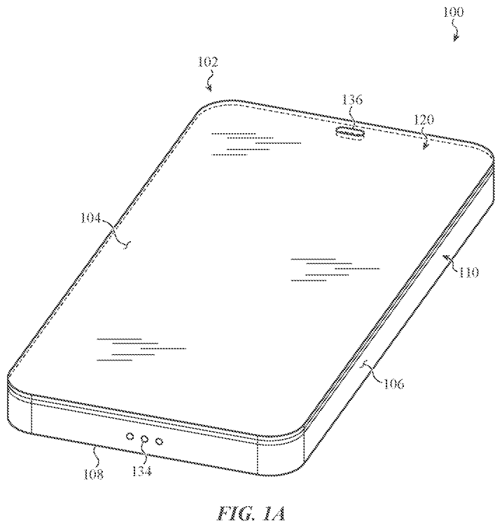

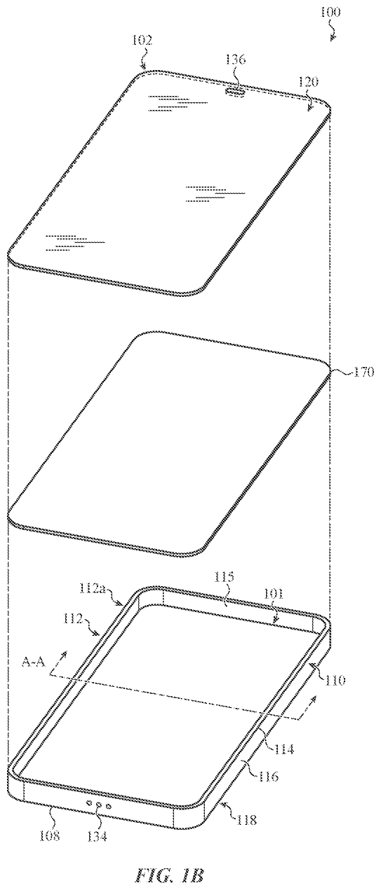

These and other embodiments are discussed below with reference to FIGS. 1A through 14. However, those skilled in the art will readily appreciate that the detailed description given herein with respect to these figures is for explanatory purposes only and should not be construed as limiting.

FIG. 1A shows an example electronic device 100. The electronic device 100 of FIG. 1A may be a portable electronic device such as a telephone or a tablet computer. In other examples, the electronic device may have the form of a display monitor, a laptop computer, a wearable electronic device (e.g., a smart watch), or another form of electronic device.

The electronic device 100 includes an enclosure 102 which may be formed at least in part from multiple layers. The enclosure defines a front surface 104, a side surface 106, and a rear surface 108. The enclosure 102 defines an internal cavity into which one or more device components may be placed (e.g., the internal cavity 101 of FIG. 1B).

As shown in FIG. 1A, the enclosure 102 includes a housing 110 and a front cover member 120. The front cover member 120 at least partially defines the front surface 104 of the enclosure 102. The front cover member 120 (and/or a rear cover member, if present) may define a transparent window over a display assembly and/or an optical component of the electronic device 100. The display assembly may include a touch sensor to form a touch-sensitive display. The front surface of the enclosure may be a surface that typically faces a user of the electronic device during operation of the electronic device.

In some embodiments, the front cover member 120 may define a substantial entirety of the front surface 104 of the enclosure 102 and may also define a portion of the side surface 106 of the enclosure 102. In other embodiments, the front cover member 120 and the housing 110 may each define a portion of the front surface 104 of the enclosure 102, such as when the housing defines an opening to an internal cavity of the enclosure 102 and the front cover member 120 is positioned within the opening.

The housing 110 may at least partially define the side surface 106 of the enclosure 102. In some embodiments, the housing 110 at least partially defines the rear surface 108 of the enclosure 102. In some examples, the housing 110 defines a substantial entirety of the rear surface 108 of the enclosure 102. In some embodiments, the enclosure may alternately or additionally include a rear cover member that at least partially defines the rear surface 108 of the enclosure 102.

In some embodiments, the front surface 104 or another surface of the enclosure may define an input surface for a touch sensor positioned within the enclosure. In some examples, the touch sensor may be incorporated into a display assembly, as previously discussed. In other examples the touch sensor need not be incorporated into a display assembly.

In some embodiments, the housing 110 is formed at least in part from multiple layers of material and may therefore be referred to as a laminate housing, as having a laminate structure, or as having a laminate construction. Examples of housings formed at least in part from multiple layers of material are shown at least in FIGS. 2A through 2E, 3A through 3F, 4A and 4B, and 5A through 5C. The techniques and principles described herein with respect to laminate housings are not limited to housings but may be applied to other laminate components (alternately, laminated components) of the electronic device, such as a cover member or a reinforcing structure. The other laminate components may partially define the enclosure or may be positioned within the internal cavity defined by the enclosure.

The laminate housing may have any of a variety of configurations. In several of the examples illustrated herein, the layers of the laminate are stacked in the vertical direction (e.g., in a direction aligned with a height of the housing). In these examples, the laminate may include a first layer defining a front surface of the housing, a second layer defining a rear surface of the housing, and at least one intermediate layer at least partially positioned between the first layer and the second layer. In some cases, the laminate includes a set of intermediate layers. However, these examples are not limiting, and, in other examples, the layers may be stacked in a width direction (e.g., in a direction aligned with a thickness of the housing), in any other suitable direction, or in different directions at different locations of the housing. In some configurations, each of the layers defines a portion of an exterior side surface of the housing. In other configurations one or more of the layers does not define a portion of the exterior side surface of the housing.

The layers of the laminate may be formed from one or more materials such as a metal, a glass, a ceramic, a polymer, or a composite material. Suitable metals include, but are not limited to, aluminum alloys, titanium alloys, steel, magnesium alloys, copper, copper alloys, and the like. Suitable polymers include, but are not limited to, thermoplastic and thermoset polymers. Suitable thermoset polymers include epoxy-based resins, unsaturated polyester resins, and vinyl ester resins Suitable glasses include, but are not limited to, silicate-based glasses. Suitable composite materials include, but are not limited to, fibers or particles in a polymer matrix. Suitable materials for the fibers or particles include, but are not limited to, a glass, a ceramic, carbon (e.g., graphite), a metal, a polymer, and combinations of these.

In some cases, each layer may have a substantially uniform composition. For example, each layer may be a metal layer, a glass layer, a ceramic layer, a polymer layer, or a composite layer. In other cases, a given layer may vary in composition and therefore may vary in one or more mechanical, electrical, optical, thermal, or other properties. For example, a layer may include regions having different stiffnesses so that the more flexible region(s) can bend or fold, as described in more detail with respect to FIGS. 5A through 5C. As another example, the layer may include regions having different thermal or electrical conductivity so that the higher conductivity region(s) create a conduction path as described in more detail with respect to FIG. 2F.

In some embodiments, the layers used to form the housing may differ in composition, allowing the composition of the layers to be tailored to provide desired mechanical, electrical, or other properties to the housing. In some cases, at least one of the layers differs in composition from another layer. For example, all the layers may be metal layers, but at least one of the metal layers may have a different composition than another metal layer. As another example, the set of layers may include multiple metal layers and at least one layer formed of a material other than a metal. As a particular example, one or more dielectric layers may be interposed between metal layers to form a radio frequency (RF) transmissive window for an RF device component within the enclosure 102.

In some embodiments, the layers used to form the housing are substantially dense (alternately, non-porous). In other embodiments, all or a portion of a layer may be porous. For example, the layer may include or be formed of a woven or a nonwoven textile. In some cases, the textile may include one or more of glass fibers, ceramic fibers, carbon (graphite) fibers, metal fibers, or polymer fibers.

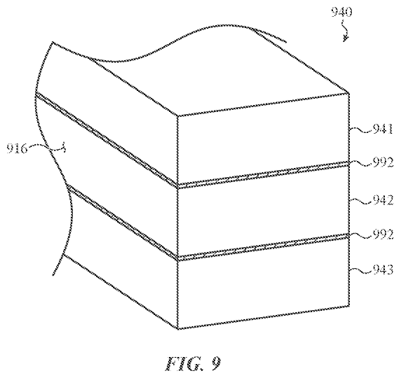

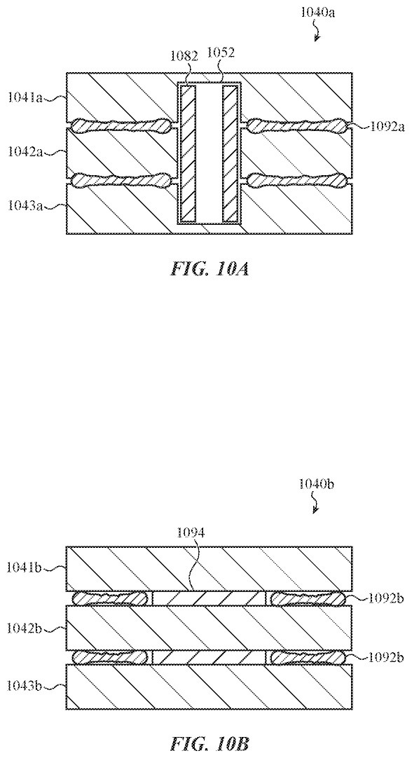

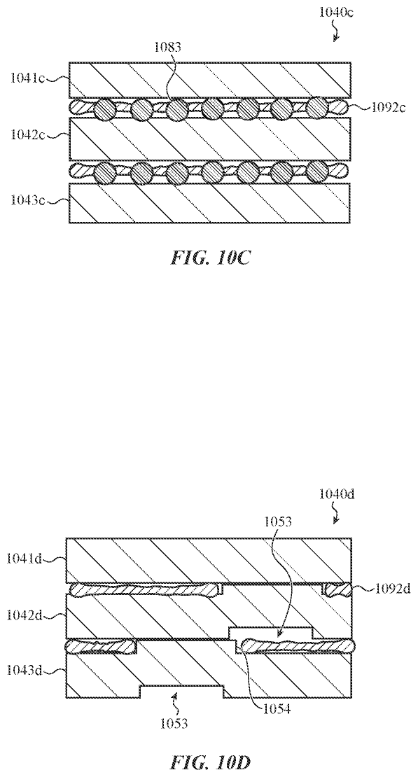

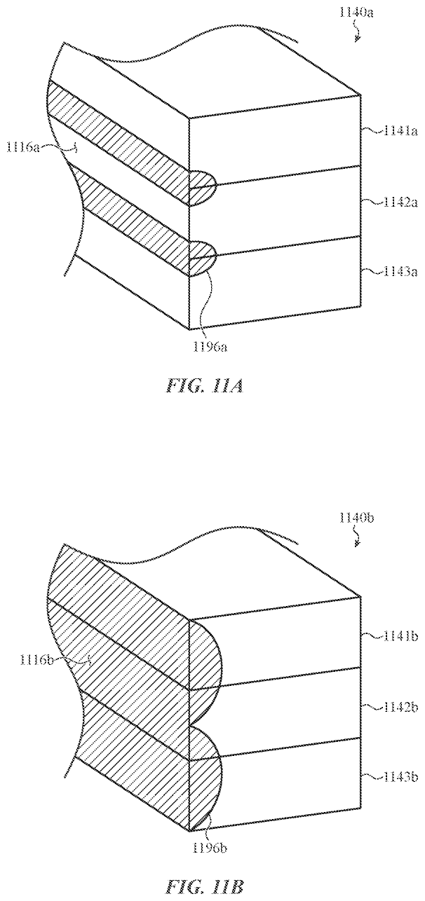

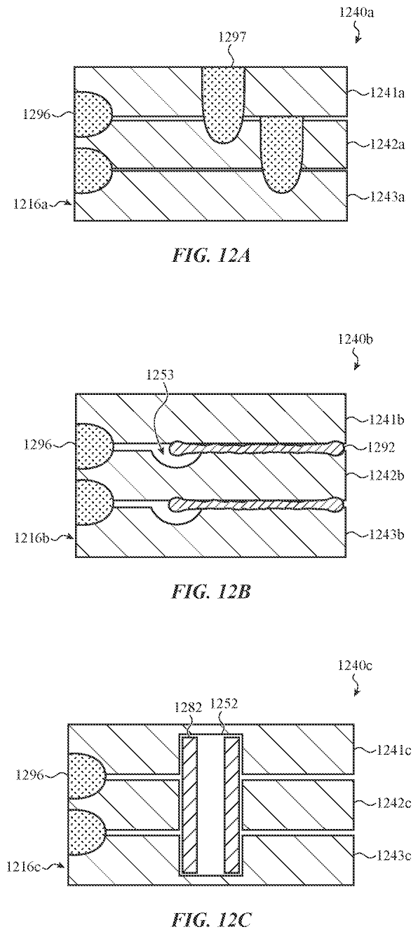

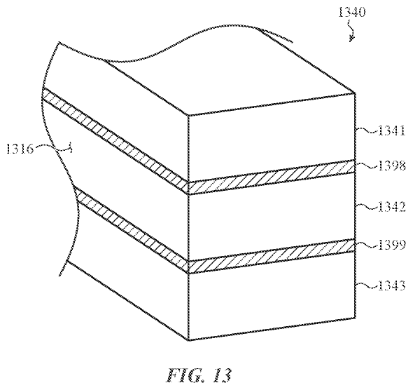

The layers of the laminate may be joined in in a variety of ways. In some embodiments, the layers may be joined with an adhesive, as described with respect to FIG. 9. Alternately or additionally, the layers may be joined with one or more interlock pins, an example of which is shown in FIG. 10A. The interlock pins may help prevent shearing motion of one layer with respect to another. The interlock pin may be press fit in place. Interlock pins formed of a metal may also facilitate electrical connection of metal layers in the laminate, as described in more detail with respect to FIG. 10A. When the layers include metal layers, the metal layers may be joined at least in part by welds as described with respect to FIGS. 11A and 11B and 12A through 12C. In some cases, layers of the laminate may be joined by diffusion bonding, as described with respect to FIG. 13. The description provided with respect to FIGS. 9 through 13 is generally applicable herein and is not repeated here.

Forming all or part of the housing 110 from multiple layers may provide a simpler method to form some housing architectures as compared to standard machining methods. For example, the layers may be assembled to form a cavity within the body of the housing, thus allowing integration of an active or a passive device component (e.g., an active or passive electronic component) within the body of the housing as shown in the example of FIG. 2A. As another example, the layers may be assembled to form a laminate structure in which one layer protrudes with respect at least one other layer of the assembly, which may form a stepped structure along an interior surface of the housing. This laminate structure may be used to form features such as an attachment feature or a feature used to structurally reinforce the enclosure, as shown in the examples of FIGS. 2B, 2E, 3B through 3F and 4A and 4B. As yet another example, the layers may be assembled so that one or more of the layers preferentially define an exterior surface of the housing, as shown in the examples of FIGS. 2D and 2E.

FIG. 1B shows a simplified exploded view of the electronic device of FIG. 1A. As shown in FIG. 1B, the electronic device 100 includes the front cover member 120, the housing 110, and a component 170 that is positioned below the front cover member 120. As previously described with respect to FIG. 1A, the housing 110 may be formed from multiple layers.

The housing 110 defines an exterior surface that includes a front surface 114, a side surface 116, and a rear surface 118. The side surface 116 may at least partially define the side surface 106 of the enclosure 102. The housing 110 also defines an interior surface 115 that at least partially defines the internal cavity 101 of the enclosure 102. In some embodiments described herein, the housing defines a stepped structure along the interior surface 115 due to protrusion of one or more layers with respect to other layers of the housing 110. The protruding layers may form or help to form one or more of an attachment feature, a base of the housing, a support plate (e.g., a midplate), or a support member (e.g., a ledge) for a cover member or a base.

The housing may define a set of side walls 112. In some examples, the set of sidewalls 112 defines a ring. The interior surface of a sidewall (e.g., 112a) may define a portion of the interior surface 115 and the exterior surface of the sidewall may define a portion of the exterior surface 116. In the example of FIGS. 1A and 1B, the housing defines a set of openings 134 that extends through the sidewall. The openings 134 may provide audio ports for a speaker and/or microphone that is positioned within the enclosure 102. The example of FIGS. 1A and 1B is not intended to be limiting and in other examples audio ports or other openings in the enclosure 102 may be located at other positions along the side surface 106, along the rear surface, 108 and/or along the front surface 104. The enclosure 102 of FIGS. 1A and 1B also defines an opening 136 in the front cover 120, which can provide an audio port and/or access to a sensor or camera. This example is not intended to be limiting and in other embodiments a front cover need not include an opening.

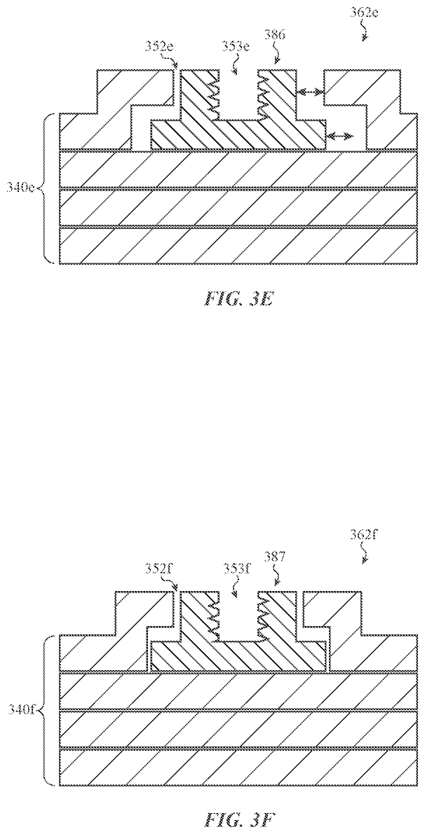

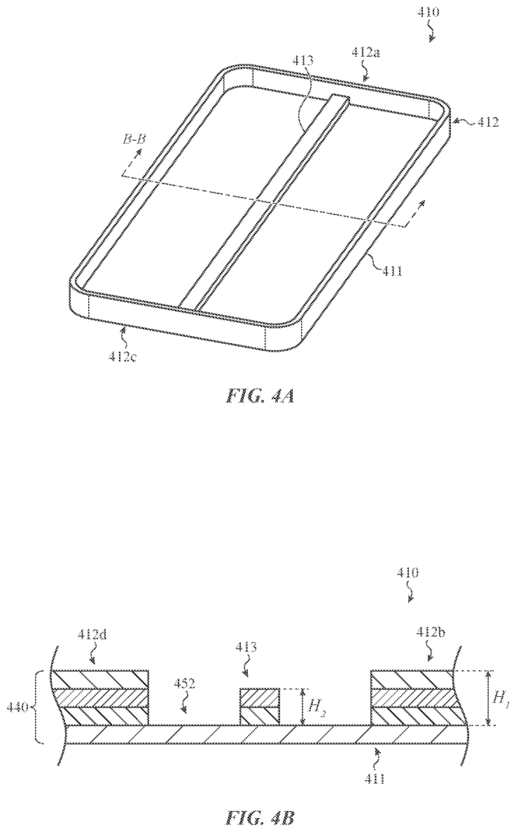

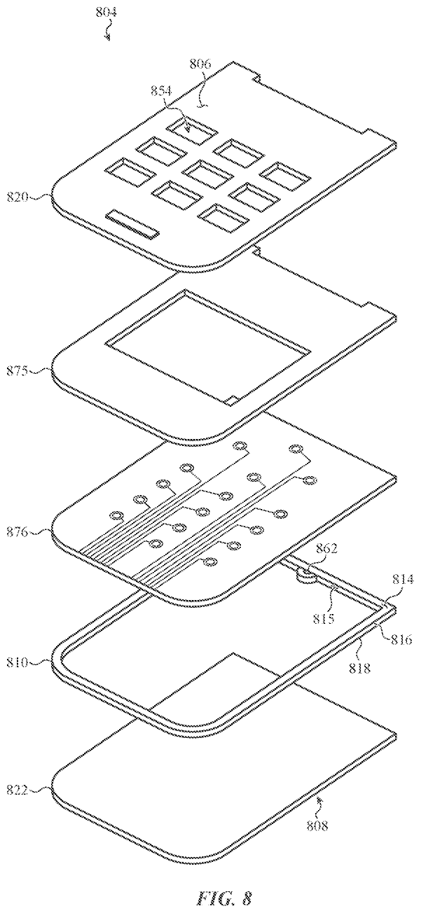

In some embodiments, the housing 110 has a laminate structure that includes a rear layer that extends between opposing sidewalls of the housing. FIGS. 4A and 4B show an example of a laminate housing including a rear layer that extends between opposing sidewalls. The rear layer may help to support various internal components of the electronic device 100 and may therefore be referred to as a base layer. In some examples, the rear layer of the laminate structure may at least partially define the rear surface 108 of the enclosure and may at least partially define a rear wall of the enclosure. In other examples, the housing 110 is coupled to a rear cover member or base member that at least partially defines the rear surface 108 of the enclosure 102, as shown in the example of FIG. 8. In these examples, the rear layer of the housing may help to support the rear cover or base member. In some cases, multiple layers, including the rear layer, may extend between opposing sidewalls of the housing.

In some embodiments, the housing 110 has a laminate structure that includes a front layer and/or one or more intermediate layers that extends between opposing sidewalls of the housing. When the enclosure includes a front cover, the front layer and/or the one or more intermediate layers may help to support the front cover or various internal components of the electronic device.

The electronic device 100 includes one or more components which are at least partially surrounded by the enclosure 102. For example, the component 170 is at least partially surrounded by the front cover member 120 and the housing 110. In some examples, the component 170 may be a display assembly, a circuit board including electronic circuitry, a reinforcing member, a battery layer, or another suitable component. In some embodiments, the front cover member 120 and the housing 110 together define the enclosure 102 and the component 170 is positioned within the enclosure 102 (e.g., in the internal cavity 101). In other embodiments, the component 170 partially defines the side surface 106 of the enclosure 102.

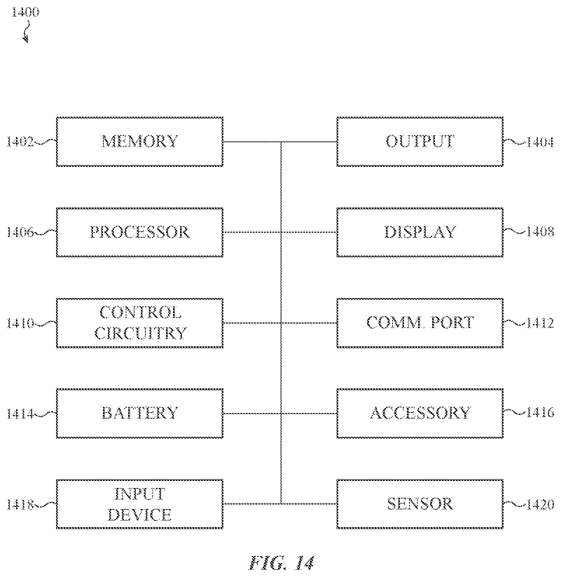

More generally, the electronic device may include all or some of the device components described with respect to FIG. 14. For example, the electronic device may include one or more of a processor, control circuitry, memory, a communication port, an output device (e.g., a display), an input device, a sensor, wireless communication circuitry, a battery, or an accessory (e.g., a camera).

FIGS. 2A through 2E show examples of cross-sectional views of laminate housings while FIG. 2F shows an example of a laminate layer. The cross-sectional views of FIGS. 2A through 2E may be examples of cross-sectional views along A-A in FIG. 1B. As shown in FIGS. 2A through 2E, the laminate housing may include a first layer (e.g., 241a) defining a front surface of the housing, a second layer (e.g., 246a) defining a rear surface of the housing, and at least one intermediate layer positioned between the first layer and the second layer. In the example of FIGS. 2A through 2E, the laminate housing includes a set of intermediate layers. The number and configuration of layers of the set of layers shown in FIGS. 2A through 2E is exemplary rather than limiting and in additional examples the set of layers may include a different total number of layers, a different number of layers that define the cavity, different thicknesses of layers, different widths of layers, and the like. The layers shown in FIGS. 2A through 2F may be any of the layers described with respect to FIGS. 1A and 1B and that description is not repeated here.

FIG. 2A shows an example of a partial cross-sectional view of a laminate housing that accommodates another component of the electronic device. As shown in FIG. 2A, the housing 210a is formed from a set of layers 240a that define a cavity 252 within the body of the housing and a component 272 is positioned within the cavity 252. In the example of FIG. 2A, the set of layers 240a define a side wall 212a of the housing 210a and the cavity 252 and the component 272 are positioned within the sidewall 212a. The example of FIG. 2A is not limiting and in additional examples the component 272 may be positioned in another location within the body of the housing 210a.

In some embodiments, the component 272 is an active electronic component or a passive electronic component. In some examples, the component 272 may be an input component, an output component, or an input/output component. In some embodiments, the component 272 may be a magnetic component, a hinge component, or another component that helps to provide a rotatable connection. The component 272 may be operably connected to electronic circuitry within an internal cavity of the enclosure. In some cases, the housing 210a may define an opening along the interior surface 215a in order to facilitate operable connection between the component 272 and the electronic circuitry.

In some embodiments, the component 272 is formed from a material which is used to modify a physical property, a mechanical property, an electrical property, a magnetic property, a heat transfer property, or the like of the housing 210a. For example, the component 272 may be formed of a material having a higher elastic modulus than an overall elastic modulus of the housing to help increase the impact resistance of the enclosure. As another example, the component 272 may be formed of a shock absorbing material and one or more of the components may be used to provide a damping path for structural shock absorption. In additional examples, the component 272 may be formed from a material having a higher electrical conductivity than an overall electrical conductivity of the housing to provide an electrical grounding path, may be formed from a material having a higher thermal conductivity than an overall thermal conductivity of the housing to increase the thermal conductivity of the enclosure, and so forth. In some cases, the component 272 may be integrated with the housing 210a via a mechanical interlock and/or via an adhesive or other bonding technique.

In the example of FIG. 2A, at least some of the layers of the set of layers 240a define an opening. The cavity 252 may be formed by assembling the set of layers so that the openings within these layers are aligned. The component 272 may be inserted as the set of layers is being assembled. In some embodiments, the cavity 252 may open to the internal cavity of the enclosure or may otherwise allow connection or communication between the component 272 and electronic circuitry of the electronic device.

In the example of FIG. 2A, the set of layers 240a includes six layers: 241a, 242a, 243a, 244a, 245a, and 246a. The layers 242a, 243a, and 244a each define an opening in the plane of the cross-section and are therefore not coextensive with the layers 241a, 245a, and 246a. Each of the layers 241a, 242a, 243a, 244a, 245a, and 246a define a portion of the exterior side surface 216a of the housing 210a. The layers 241a, 242a, 243a, 244a, and 245a together define a side portion of the interior surface 215a of the housing 210a. The front layer 241a defines a front surface 214a and the rear layer 246a defines a rear exterior surface 218a of the housing 210a. The layers 242a, 243a, 244a, and 245a may be referred to as intermediate layers.

FIG. 2B shows an example of a partial cross-sectional view of a laminate housing that defines an attachment feature. As shown in FIG. 2B, the housing 210b is formed from a set of layers 240b that define a side wall 212b of the housing 210b. The set of layers 240b defines an attachment feature 262, which has the form of a boss. In the example of FIG. 2B, the attachment feature 262 includes a threaded insert 282. The set of layers 240b includes six layers: 241b, 242b, 243b, 244b, 245b, and 246b.

As shown in FIG. 2B, the attachment feature 262 is defined by layers that protrude with respect to other layers along the interior surface 215b of the housing 210b. The attachment feature 262 also includes a threaded insert 282 that is positioned in a hole formed through the layers 243b, 244b, and 245b. In the example of FIG. 2B, the layers 243b, 244b, and 245b protrude with respect to the portions of the interior surface of the housing defined by the layers 241b and 242b. The layers 243b, 244b, and 245b are therefore not coextensive with the layers 241b and 242b. The layer 246b also protrudes with respect to the other layers.

As shown in FIG. 2B, each of the layers 241b, 242b, 243b, 244b, 245b, and 246b define a portion of the exterior side surface 216b of the housing 210b. The layers 241b, 242b, 243b, 244b, and 245b together define a side portion of the interior surface 215b of the housing 210b. The layer 241b defines a front surface 214b and the layer 246b defines a rear surface 218b of the housing 210b.

FIG. 2C shows an example of a cross-sectional view of another laminate housing. The set of layers 240c includes five layers: 241c, 242c, 243c, 244c, and 245c. In some embodiments, the layer 243c defines all or part of a hinge (e.g., a living hinge). The layer 243c protrudes with respect to the other layers 241c, 242c, 244c, and 245c along an interior surface 215c of the laminate housing. As shown in the example of FIG. 2C, the layer 243c extends between opposing sidewalls 212c of the housing 210c. In some examples, each of the layers 241c, 242c, 243c, 244c, and 255c may be formed of a metal. In other examples, the layer 243c may be formed of a material that is more flexible than the material(s) used to form the layers 241c, 242c, 244c, and 255c, which can permit bending or folding of the housing 210c. As a particular example, the layer 243c may be formed from a polymer material or another material capable of bending or folding and the layers 241c, 242c, 244c, and 255c may be formed from one or more metal materials. In other examples, the layer 243c may be formed from multiple materials and may define a flexible region that is formed of a polymer material or another material capable of bending or folding and another region that is formed of a material that has a stiffness greater than that of the flexible region. Examples of layers with flexible regions are described in more detail with respect to FIGS. 5A-5C and that description is generally applicable herein.

FIGS. 2D and 2E show other example partial cross-sectional views of laminate housings. In the examples of FIGS. 2D and 2E, the exterior side surface of the housing is defined by one layer of the set of layers. In other words, not all of the layers of the laminate extend to the exterior side surface of the housing (e.g., 216d, 216c).

FIG. 2D shows an example in which one layer of the set of layers 240d defines the entire side surface 216d of the housing 210d. The set of layers 240d includes six layers: 241d, 242d, 243d, 244d, 245d, and 246d. In the example of FIG. 2D, the bottom layer 246d of the set of layers 240d defines the bottom surface 218d and an entirety of the side surface 216d of the housing 210d. Although the example of FIG. 2D shows the bottom layer 246d as defining the side surface 216d, in other examples the top layer 241d may instead define the side surface 216d. FIG. 2D also shows the sidewall 212d, the top surface 214d, and the interior surface 215d of the housing 210d.

FIG. 2E shows an example in which an intermediate layer of the set of layers 240e defines the side surface 216e of the housing 210e. The set of layers 240e includes five layers: 241c, 242c, 243c, 244c, and 245c. As shown in FIG. 2E, the intermediate layer 243e has a T-shaped cross-section, with the crossbar of the T-shape defining the side surface 216e. In the example of FIG. 2E, the intermediate layer 243e protrudes with respect to other layers along an interior surface 215e of the housing 210e in a similar fashion as previously described with respect to FIGS. 2B and 2C. However, this example is not limiting and in other examples the intermediate layer 243e may be flush with other layers of the set of layers or multiple intermediate layers may protrude with respect to another layer of the set of layers. As shown in FIG. 2E, the intermediate layer 243e is thicker than the other layers, but this example is not limiting. In some cases, the intermediate layer 243e may provide structural reinforcement to the housing 210e. In other examples, one intermediate layer may form an upper portion of the crossbar of the T-shape and an upper portion of the exterior side surface 216e while another interior layer may form a lower portion of the crossbar of the T-shape and a lower portion of the exterior side surface 216e. FIG. 2E also shows the sidewall 212e, the top surface 214c, the interior surface 215e, and the rear surface 218e of the housing 210c.

FIG. 2F shows an example of a layer of a laminate housing. In the example of FIG. 2F, the composition of the region 264 may differ from that of another region 265 of the layer 243f. In some embodiments, the region 265 may include or be formed from a metal, a ceramic, or a composite material. The region 264 may be formed of a different material than the region 265 in order to modify a property of the layer 243f as compared to a layer formed solely from the material of the region 265. For example, the layer 243f may have at least one of increased damping or shock absorption, strength, elastic modulus, electrical conductivity or thermal conductivity as compared to a layer formed solely from the material of the region 265. In some examples, the region 264 may be mechanically interlocked with the region 265 or diffusion bonded to the region 265. The laminate housing may include one or more layers having regions of different composition.

In some embodiments, the region 264 is formed of a material that has a greater ability to absorb impact than that of the region 265, which can help provide shock resistance to an electronic device having a housing including the layer 243f. In some embodiments, the region 264 may include or may be formed of a polymer material or another material capable providing shock resistance to the housing. As shown in FIG. 2F, the regions 264 are positioned in the vicinity of the corners 219 of the layer 243f and therefore may help protect the electronic device from an impact to one or more of the corners 219. In other examples the regions 264 may be positioned in additional regions of the electronic device as desired to increase the shock resistance of the electronic device.

In some embodiments, the region 264 is formed of a material having a higher elastic modulus than the material of the region 265. For example, the region 265 may be formed from an aluminum alloy and the region 264 may be formed from a titanium alloy or steel. A titanium alloy or steel region having a higher elastic modulus (e.g., Young's modulus) than the aluminum alloy in the vicinity of a corner 219 of the layer 243f may act as a corner support and help prevent damage to the housing from an impact to the corner 219.

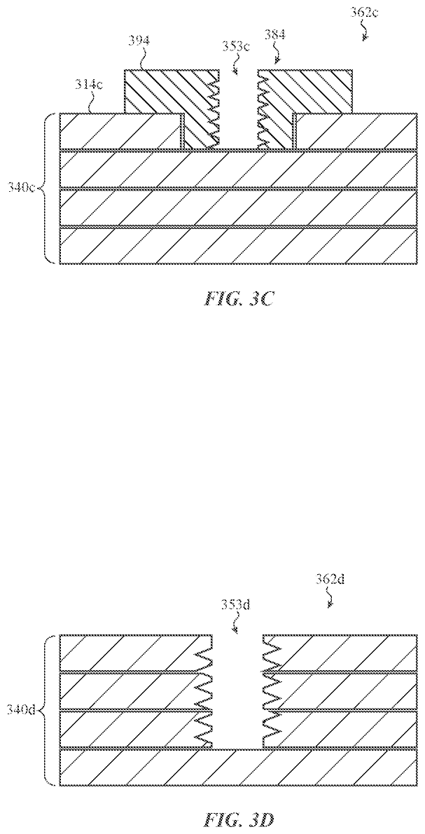

FIGS. 3A, 3B, 3C, 3D, 3E, and 3F show other examples of partial cross-sectional views of attachment features formed in a laminate structure. The attachment feature may be part of a laminate housing, as was previously described with respect to FIG. 2B, and may be a laminate attachment feature. However, the views of FIGS. 3A through 3F are magnified as compared to the view of FIG. 2B in order to show further details of the attachment features. The number and configuration of the layers of the set of layers shown in FIGS. 3A through 3F is exemplary rather than limiting and in additional examples the set of layers may include a different total number of layers, a different number of layers that define a cavity of the attachment feature, different thicknesses of layers, and the like. Furthermore, the layers of the set of layers may be any of the layers described with respect to FIGS. 1A and 1B and that description is not repeated here. Alternately or additionally, the electronic device may include other types of fasteners such as magnetic fasteners or snaps. In some embodiments, these other types of fasteners may be integrated into the laminate structure following the general principles described herein. The cross-sectional views of FIGS. 3A through 3F may be examples of cross-sectional views along A-A in FIG. 1B.

FIG. 3A shows an attachment feature 362a formed in a laminate structure comprising a set of layers 340a. The set of layers 340a define a cavity 352a and an insert 382 is positioned within the cavity 352a. For example, the insert 382 may be press fit within the cavity or attached by an adhesive. The insert 382 defines a threaded hole 353a.

FIG. 3B shows another attachment feature 362b formed in a laminate structure comprising a set of layers 340b. In the example of FIG. 3B, the insert 383 is integrated with the set of layers 340b so that a mechanical interlock is formed between the insert 383 and the set of layers 340b. The insert 383 of FIG. 3B may be assembled with the layers of the set of layers 340b. The insert 383 defines a threaded hole 353b.

FIG. 3C shows another attachment feature 362c formed in a laminate structure comprising a set of layers 340c. In the example of FIG. 3C, a first portion of the insert 384 is inserted into the set of layers 340c and a second portion of the insert 384 protrudes from a surface 314c (e.g., a front surface) defined by the set of layers 340c. The offset between the surface 394 of the insert 384 and the surface 314c of the set of layers 340c therefore defines a “standoff” between the set of layers 340c and the part to be fastened to the insert 384. The insert may be assembled with the set of layers 340c or after the set of layers 340c has been assembled. The insert 384 defines a threaded hole 353c.

FIG. 3D shows another attachment feature 362d formed in a laminate structure comprising a set of layers 340d. In contrast to the examples of FIG. 3A through 3C, the attachment feature 362d does not include an insert. Instead, a threaded hole 353d is formed into the set of layers 340d. In some examples, the layers of the set of layers 340d may be assembled to form a hole and the threads may be formed into the walls of the cavity. In other examples, a hole may be drilled into the set of layers 340d, and the threads formed afterwards.

FIG. 3E shows another attachment feature 362e formed in a laminate structure comprising a set of layers 340c. In the example of FIG. 3E, the insert 386 has a lower portion that is wider than its upper portion and the set of layers 340e is configured to encapsulate the insert accordingly. As shown in FIG. 3E, the upper layer of the set of layers 340e is not flat but is shaped to define a cavity 352e for the insert 386. In particular, a portion of the upper layer that is proximate the upper portion of the insert is elevated with respect to a portion of the upper layer that adjoins its neighboring layer in the set of layers 340e. In this example, the cavity 352e is sized to allow some extent of lateral movement of the insert 386 within the cavity 352e (schematically indicated by the arrows). The insert 386 includes a threaded hole 353c. The insert 386 may be assembled with the set of layers 340c.

FIG. 3F shows another attachment feature 362f formed in a laminate structure comprising a set of layers 340f. The attachment feature 362f is similar to that of the attachment feature 362e with respect to the shape of the insert and the shape of the upper layer of the set of layers. However, the cavity 352f is sized to allow a lesser extent of extent of lateral movement of the insert 387 within the cavity 352f. The insert 387 includes a threaded hole 353f and may be assembled with the set of layers 340f in a similar manner as previously discussed with respect to FIG. 3E.

FIG. 4A shows another example of a housing of an electronic device. The housing 410 may be a laminate housing, as shown in the partial cross-sectional view of FIG. 4B. The housing 410 is formed from a set of layers 440 and includes a base 411 and a set of side walls 412. The housing 410 also includes a feature 413 which extends between a pair of opposing side walls 412a and 412c of the set of sidewalls 412. The view of FIG. 4B may be taken along the cross-section B-B of FIG. 4A.

As shown in FIGS. 4A and 4B, the feature 413 may have the form of a rib which protrudes from the base 411 of the housing 410. The feature 413 may help to structurally reinforce the base 411, may help to define regions or “pockets” (e.g., 452) to locate other components of the electronic device, and/or may provide a laminate structure which may define an attachment feature in a similar fashion as previously described with respect to FIGS. 2B and 3A through 3F. In other examples, the rib may have a different orientation and/or the housing may define multiple ribs which extend fully or partially across the base of the housing.

In some embodiments, the feature may be formed from fewer layers than another portion of the housing. In these embodiments, the feature may have a height that is less than a height of a side wall of the housing. In the example of FIG. 4B, the feature 413 is formed from fewer layers than the sidewalls 412b and 412d and has a height H₂ that is less than the height H₁ of the sidewalls 412b and 412d. The number and configuration of the layers of the set of layers shown in FIGS. 4A and 4B is exemplary rather than limiting and in additional examples the set of layers may include a different total number of layers, a different number of layers that define the feature, different thicknesses of layers, and the like. Furthermore, the layers of the set of layers may be any of the layers described with respect to FIGS. 1A and 1B and that description is not repeated here.

FIG. 5A shows another example of a housing of an electronic device. The housing 510 may be a laminate housing, as shown in the partial cross-sectional views of FIGS. 5B and 5C. The housing 510 is formed from a set of layers (e.g., 540b of FIG. 5B, 540c of FIG. 5C). The housing 510 includes a base 511a and a set of side walls 512a. The base 511a includes a flexible region 564a, which in some cases may be bendable or foldable. The views of FIGS. 5B and 5C may be taken along the cross-section C-C of FIG. 5A. As schematically shown in FIG. 5A, some sidewalls of the sidewalls 512a may include a feature that allows bending or folding of the housing 510. In the example of FIG. 5A, some of the sidewalls include a notch, but in additional examples the sidewalls may include a hinge or another type of feature to allow bending or folding of the housing 510.

As schematically shown in FIG. 5B, the composition of the flexible region 564b may differ from that of another region 565b of the base 511b. The flexible region 564b may be an example of the flexible region 564a of FIG. 5A. In some embodiments, the region 565b is formed of a material that has a stiffness greater than that of the flexible region 564b. In some examples, the flexible region 564b may include or may be formed of a polymer material or another material capable of bending or folding. In some cases, the flexible region 564b may include or be formed of a textile, which may be any of the textiles previously described with respect to FIGS. 1A and 1B. When the flexible region 564b defines a portion of the exterior surface of the enclosure, the material used to form the flexible region 564b may provide a balance of flexibility and durability. In some embodiments, the region 565b may include or be formed from a metal, a ceramic, or a composite material having the desired mechanical properties. The sidewall 512b is also shown in FIG. 5B.

In some cases, the flexible region 564b, the region 565b, or both may be formed of multiple layers. When a multilayer flexible region 564c defines a portion of the exterior surface of the enclosure, the layer of the flexible region 564c that defines the portion of the exterior surface of the enclosure may be formed from a layer that has greater durability than an interior layer of the flexible region 564c.

FIG. 5C shows an example of an enlarged partial cross-sectional view of a base 511c including multiple layers, which may be an example of the base 511a of FIG. 5A. The variation in the width of the flexible region 564c allows the layers defining the region 565c to mechanically interlock with the flexible region 564c. In some cases, the flexible region 564c may also be formed of multiple layers, as previously described with respect to FIG. 5B. The number and configuration of the layers of the set of layers shown in FIGS. 5B and 5C is exemplary rather than limiting and in additional examples the set of layers may include a different total number of layers, a different number of layers that define the feature, different thicknesses of layers, and the like. Furthermore, the layers of the set of layers may be any of the layers described with respect to FIGS. 1A and 1B and that description is not repeated here.

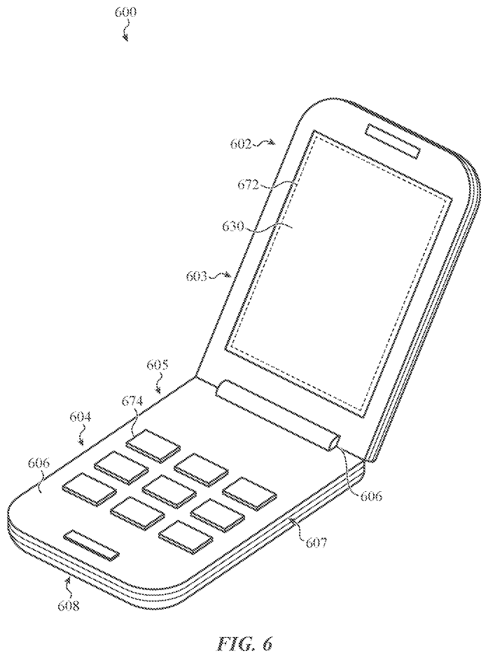

FIG. 6 shows another example electronic device. A first portion 602 of the electronic device 600 includes a first enclosure 603 and a second portion 604 of the electronic device 600 includes a second enclosure 605. The first enclosure 603, the second enclosure 605, or both may be formed at least in part from multiple layers. The first portion 602 and the second portion 604 of the electronic device 600 may be rotatably connected (e.g., with hinge 601) so that the electronic device 600 may be rotated between an open and a closed configuration. The first portion 602 may alternately be referred to as an upper portion and the second portion 604 may alternately be referred to as a lower portion of the electronic device 600.

The first portion 602 of the electronic device 600 includes a display assembly 672. The first enclosure 603 may include at least partially transparent cover member 630 and the display assembly 672 may be positioned under the cover member 630 (and is therefore indicated with dashed lines). The display assembly 672 may convey visual information to the user, such as text, digits, images, graphical user interfaces, and the like. The display assembly 672 may alternately be referred to herein as a display. In some embodiments, the display assembly 672 may be a touch-sensitive display, also referred to herein as a touch screen display. The display assembly 672 may have any of the features described with respect to the display 1408 and that description is not repeated here. The first portion 602 of the electronic device 600 may also include one or more optical components such as a camera component, a sensor component, a light source, or the like.

The second portion 604 of the electronic device 600 includes one or more input mechanisms. In the example of FIG. 6, the second portion 604 of the electronic device 600 includes a set of keys 674 to provide an input mechanism. Alternately or additionally, the second portion 604 of the electronic device 600 may include one or more buttons and/or the second enclosure 605 may define an input surface that is receptive to touch inputs, force inputs, or combinations thereof. In some embodiments, the first enclosure 603 and/or the second enclosure 605 may include one or more openings that provide an audio port for a speaker and/or microphone, an example of which was previously shown and described with respect to FIGS. 1A and 1B and that description is generally applicable herein.

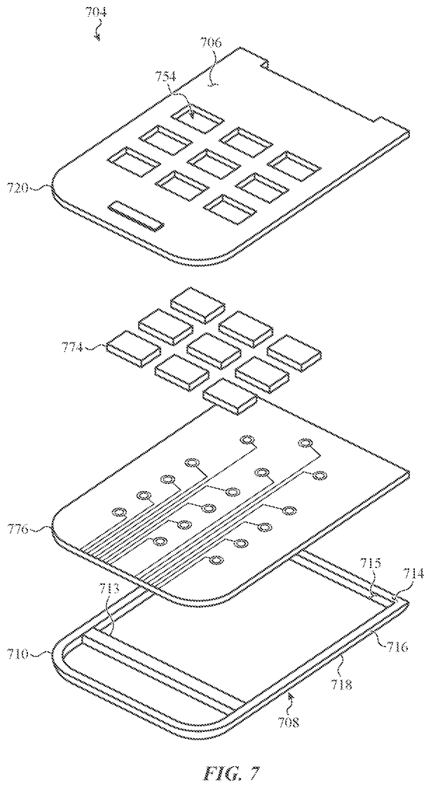

In some embodiments, the second enclosure 605 is formed at least in part from multiple layers. In some examples, the second enclosure 605 includes a housing that is formed at least in part from one or more layers. Alternately or additionally, the second enclosure 605 may include a cover member that is formed at least in part from one or more layers. Additional description of housings and cover members is provided with respect to FIGS. 7 and 8 and that description is not repeated here. As shown in FIG. 6, the second enclosure 605 defines a front surface 606, a side surface 607, and a rear surface 608.

FIG. 7 shows a simplified example of an exploded view of the second portion of electronic device of FIG. 6. As shown in FIG. 7, the second portion 704 of the electronic device includes a cover member 720, a set of keys 774, a component 776, and a housing 710. In some embodiments, the second portion 704 of the electronic device has an enclosure that is formed at least in part from multiple layers. In some examples, each of the cover member 720 and the housing 710 defines a layer of the enclosure. Alternately or additionally, one or more of the cover member 720 or the housing 710 may be formed at least in part from multiple layers.

In the example of FIG. 7, the cover member 720 defines a front surface 706 of the second portion 704 of the electronic device. The cover member 720 may be formed from one or more materials such as a metal, a glass, a ceramic, a polymer, or a composite material. As a specific example, the composite material may include fibers or particles in a polymer matrix. Suitable materials for the fibers or particles include, but are not limited to, a glass, a ceramic, carbon, a metal, a polymer, and combinations of these. The cover member 720 may be coupled to the housing 710 using one or more of the lamination techniques described herein and/or may be coupled to the housing 710 with a fastener such as a bolt, a screw, a latch, a clip, or the like. The cover member 720 may define a layer and/or the cover member 720 may be formed at least in part from multiple layers. These layers may be any of the layers described with respect to FIGS. 1A and 1B and that description is not repeated here. A laminate cover member 720 may include one or more features such as stepped structures along an interior surface of the cover member, attachment features, reinforcing features, flexible regions, and the like. The description of these features that was previously provided with respect to FIGS. 1A through 5C is generally applicable herein and is not repeated here.

As shown in the example of FIG. 7, the cover member 720 defines a set of openings 754. When the cover member 720 is assembled with the set of keys 774, each key of the set of keys may extend into a respective opening of the set of openings 754. The number of keys 774 and the number of openings 754 shown in FIG. 7 is exemplary rather than limiting and in additional examples, the cover member may define additional openings for additional input devices, may define fewer openings, or may not define any openings.

In the example of FIG. 7, the housing 710 defines a rear surface 708 of the second portion 704 of the electronic device. The exterior surface of the housing 710 includes a front surface 714, a rear surface 718, an exterior side surface 716, and an interior surface 715. The exterior side surface 716 of the housing at least partially defines a side surface (e.g., 607 of FIG. 6) of the enclosure and of the second portion 704 of the electronic device. The housing 710 defines a feature 713, which may have similar functions and properties to the feature 413 of FIGS. 4A and 4B.

The housing 710 may be formed from one or more materials such as a metal, a glass, a ceramic, a polymer, or a composite material. As a specific example, the composite material may include fibers or particles in a polymer matrix. Suitable materials for the fibers or particles include, but are not limited to, a glass, a ceramic, carbon, a metal, a polymer and combinations of these. In some embodiments, the housing 710 may be formed at least in part from multiple layers. These layers may be any of the layers described with respect to FIGS. 1A and 1B and that description is not repeated here. A laminate housing 710 may include one or more features such as stepped structures along an interior surface of the housing, attachment features, reinforcing features, flexible regions, and the like. The description of these features that was previously provided with respect to FIGS. 1A through 5C is generally applicable herein and is not repeated here.

In some embodiments, the component 776 provides computing and/or electrical functions to the device. For example, the component 776 may include electronic circuitry, which may be provided on a circuit board. Alternately or additionally the component 776 may include switches for the set of keys 774. In some cases, the cover member 720 and the housing 710 together define the enclosure (e.g., 605 of FIG. 6) and the component 776 is positioned within the enclosure (e.g., in the internal cavity). In other embodiments, the component 776 partially defines the side surface of the enclosure. In some cases, the component 776 may be formed at least in part from multiple layers.

FIG. 8 shows another simplified example of an exploded view of the electronic device of FIG. 6. As shown in FIG. 8, the second portion 804 of the electronic device includes a cover member 820, a structure 875, a component 876, a housing 810, and a base 822. The cover member 820 defines a set of openings 854. The second portion 804 may also include a set of keys that is similar to the set of keys previously shown in FIG. 7. In some embodiments, the second portion 804 of the electronic device has an enclosure that is formed at least in part from multiple layers. In some examples, each of the cover member 820, the structure 875, the housing 810, and the base 822 defines a layer of the enclosure. Alternately or additionally, one or more of the cover member 820, the structure 875, the housing 810, or the base 822 may be formed at least in part from multiple layers.

The cover member 820, the housing 810, and the base 822 together at least partly define the enclosure of the second portion 804. The cover member 820 defines at least a portion of the front surface 806 and the base 822 defines at least a portion of the rear surface 808 of the second portion 804 of the electronic device. The exterior surface of the housing 810 includes a front surface 814, a rear surface 818, an exterior side surface 816, and an interior surface 815. The exterior side surface 816 of the housing at least partially defines a side surface of the enclosure (e.g., 607 of FIG. 6). The housing 810 defines an attachment feature 862, which may have similar functions and properties to the attachment features shown in FIGS. 2B and 3A through 3F.

In some cases, the cover member 820, the housing 810 and the base 822 together define the enclosure (e.g., 605 of FIG. 6) and the structure 875 and the component 876 are positioned within the enclosure (e.g., in the internal cavity). In other embodiments, the structure 875 and/or the component 876 may partially define the side surface of the enclosure. The cover member 820, the housing 810, and the component 876 may have similar functions, may be formed from similar materials, and may have similar features as previously described with respect to the cover member 720, the housing 710, and the component 776 of FIG. 7 and that description is not repeated here. The base 822 may define a rear wall of the enclosure and may be formed from similar materials and may have similar features as previously described with respect to the cover member 720.

In some embodiments, the structure 875 provides structural reinforcement to the cover layer 820. As shown in the example of FIG. 8, the structure 875 has the form of a plate that defines at least one opening. In some embodiments, the structure 875 may define a midplate of the enclosure that is positioned between front and rear surfaces of the enclosure. The structure 875 may be formed from one or more materials such as a metal, a glass, a ceramic, a polymer, or a composite material. As a specific example, the composite material may include fibers or particles in a polymer matrix. Suitable materials for the fibers or particles include, but are not limited to, a glass, a ceramic, carbon, a metal, a polymer, and combinations of these. In some embodiments, the structure 875 may be formed at least in part from multiple layers. These layers may be any of the layers described with respect to FIGS. 1A and 1B and that description is not repeated here. A laminate structure 875 may include one or more features such as attachment features, reinforcing features, flexible regions, and the like. The description of these features that was previously provided with respect to FIGS. 1A through 5C is generally applicable herein and is not repeated here.

FIG. 9 shows an example of a partial cross-sectional view of a laminate structure that includes an adhesive. The laminate structure 940 includes three layers 941, 942, and 943 that are coupled by an adhesive 992. The thickness of the adhesive 992 may be less than the thickness of the layers of the laminate structure 940 so that the side surface 916 of the laminate structure is primarily formed by the layers 941, 942, and 943. In some embodiments, the adhesive, after curing, may be resistant to degradation during a process for anodizing the housing. The adhesive 992 may be any suitable adhesive, including acrylate-based adhesives, cyanoacrylate-based adhesives, polyurethane-based adhesives, and epoxy-based adhesives. In some examples, the adhesive 992 is a moisture-cure adhesive. Moisture-cure adhesives include, but are not limited to, polyurethane-based adhesives and silicone-based adhesives. In additional examples, the adhesive 992 is an electrically debondable adhesive. The layers of the laminate structure 940 may be any of the layers described with respect to FIGS. 1A and 1B and that description is not repeated here. The number and configuration of the layers of the laminate structure 940 is exemplary rather than limiting and in additional examples the laminate structure may include a different number of layers, different thicknesses of layers, and the like. The view of FIG. 9 may be an example partial cross-sectional view of the housing 110 of FIG. 1B along A-A or an example of another housing described herein.

The process for forming the laminate structure 940 may include several operations. During the operation of assembling the laminate structure, the adhesive 992 may be introduced between the layers (e.g., 941, 942, and 943). The operation of curing the adhesive may depend on the type of adhesive, but in some cases, pressure may be applied during the curing process. In some embodiments, a machining operation and/or a finishing operation may be performed on one or more faces of the laminate structure after the curing operation. In some cases, a face of the laminate structure that defines an external surface of the enclosure may be co-machined so that the exterior faces of the layers are even with each other. After the co-machining process, the surface may be brushed, such as along the junctions between the layers. Alternately or additionally, the surface may be grit blasted. In some cases, an anodizing operation may form an oxide layer along one or more metal surfaces of the laminate structure. The anodizing operation is typically an electrochemical operation that forms an oxide layer along a metal surface. In some cases, the oxide layer may be formed on selected layers of the laminate during the anodizing operation by conductively coupling these selected layers. In some examples, the oxide layer may be colored by introducing a dye into pores of the oxide layer.

An exterior surface of the laminate may have a substantially uniform appearance or may have a multicolored appearance. In some embodiments, the multicolored appearance may be obtained by using layers of different materials to form the exterior surface of the laminate. In some embodiments, the multicolored appearance may be obtained by anodizing and dyeing only selected layers of the laminate.

FIGS. 10A, 10B, 10C, and 10D show additional examples of partial cross-sectional views of laminate structures that include an adhesive. In contrast to the example of FIG. 9, the laminate structures of FIGS. 10A, 10B, 10C, and 10D include features such as an interlock pin, an additional adhesive, spacer beads, a shear-resistant feature formed in the layers, and the like in combination with the adhesive. The layers of the laminate structures 1040a, 1040b, 1040c, and 1040d may be any of the layers described with respect to FIGS. 1A and 1B and that description is not repeated here. The number and configuration of the layers of the laminate structures shown in FIGS. 10A, 10B, 10C, and 10D is exemplary rather than limiting and in additional examples the laminate structure may include a different number of layers, different thicknesses of layers, and the like. The views of FIGS. 10A, 10B, 10C, and 10D may be examples of partial cross-sectional views of the housing 110 of FIG. 1B along A-A or examples of other housings described herein.

FIG. 10A shows a laminate structure that includes an interlock pin in addition to the adhesive. As shown in FIG. 10A, the laminate structure 1040a includes layers 1041a, 1042a, and 1043a and the layers of the laminate structure 1040a define a recess 1052 that extends through multiple layers of the laminate structure 1040a. An interlock pin 1082 is positioned within the recess 1052 and helps prevent shearing motion of one layer with respect to another layer. The size of the recess 1052 is exaggerated for purposes of illustration and in some embodiments the interlock pin 1082 may be press-fit within the recess 1052. The interlock pin 1082 may be formed of a material having an elastic modulus that is greater than an elastic modulus of at least one of the layers. For example, when the layers are formed from an aluminum alloy, the interlock pin 1082 may be formed of a titanium alloy. When an electrically insulating adhesive is provided between metal layers, an interlock pin formed of a metal may also help to electrically connect the metal layers. For example, such an interlock pin may facilitate grounding of metal layers in the laminate structure. The interlock pin 1082 may be hollow or solid. In the example of FIG. 10A, an adhesive 1092a is provided between the layers in a similar fashion as previously described with respect to FIG. 9. In additional examples, the adhesive 1092a may be omitted or provided only in selected areas of the laminate structure. The adhesive 1092a may be any of the adhesives previously described with respect to FIG. 9.

FIG. 10B shows a laminate structure that includes two different types of adhesives. As shown in FIG. 10B, the laminate structure 1040b includes layers 1041b, 1042b, and 1043b and a first adhesive 1092b and a second adhesive 1094 are positioned between adjacent pairs of layers of the laminate structure 1040b. The first adhesive 1092b may define a first portion of the junction between an adjacent pair of layers and the second adhesive 1094 may define a second portion of the junction between the adjacent pair of layers. The first adhesive 1092b may be any of the adhesives previously described with respect to FIG. 9. The second adhesive may be an electrically conductive adhesive, and, in some embodiments, may be a conductive pressure sensitive adhesive. When the first adhesive 1092b is electrically insulating, an electrically conductive second adhesive 1094 may help to electrically connect metal layers of the laminate structure (e.g., to facilitate grounding of the metal layers).

FIG. 10C shows a laminate structure that includes spacer beads in addition to the adhesive. As shown in FIG. 10C, the laminate structure 1040c includes layers 1041c, 1042c, and 1043c and a mixture of spacer beads 1083 and adhesive 1092c are provided between adjacent pairs of layers of the laminate structure 1040c. The spacer beads 1083 may be sized to provide a desired spacing between adjacent pairs of layers of the laminate structure 1040c. In some examples, the beads 1083 may be formed of a glass material, a ceramic material, a metal material, or another suitable material. In additional examples, particles having the desired size range may be substituted for the beads 1083. The adhesive 1092c may be any of the adhesives previously described with respect to FIG. 9.

FIG. 10D shows a laminate structure that includes shear-resistant features formed in the layers in addition to the adhesive. As shown in FIG. 10D, the laminate structure 1040d includes layers 1041d, 1042d, and 1043d and each of the lower pair of adjacent layers (1042d and 1043d) includes a protrusion 1054 on an upper surface of the layer and a recess 1053 formed on a lower surface of the layer. The configuration of the protrusions 1054 and the recesses 1053 shown in FIG. 10D may limit relative movement of the layers under shear loading due to mechanical interlocking of the protrusions 1054 and the recesses 1053. Therefore, the protrusions 1054 and the recesses 1053 are referred to herein as shear-resistant features. In some cases, the shear resistant features may be formed by partially stamping adjacent layers into each other. In some examples, a half-shearing process may be used to form the protrusions and recesses. The configuration of shear-resistant features shown in FIG. 10D is exemplary rather than limiting and other configurations of shear-resistant features may operate on a similar principle as illustrated in FIG. 10D. In the example of FIG. 10D, an adhesive 1092d is placed between adjacent pairs of layers of the laminate structure 1040d and may be any of the adhesives previously described with respect to FIG. 9.

FIGS. 11A and 11B show examples of partial cross-sectional views of laminate structures that include a weld. Both of the welds 1196a and 1196b extend inwards from their respective laminate surfaces. However, the welds 1196a and 1196b have different sizes, as described in more detail below. The weld sizes shown in FIGS. 11A and 11B are intended to be exemplary rather than limiting and in other examples the width and/or depth of the weld may differ from the examples of FIGS. 11A and 11B. The number and configuration of the layers of the laminate structures 1140a and 1140b are exemplary rather than limiting and in additional examples the laminate structure may include a different number of layers, different thicknesses of layers, and the like. The views of FIGS. 11A and 11B may be examples of partial cross-sectional views of the housing 110 of FIG. 1B along A-A or examples of other housings described herein.

In the example of FIG. 11A, the welds 1196a are located primarily along the junction between two adjacent layers of the laminate structure 1140a at the surface 1116a. In the example of FIG. 11B, the welds 1196b extend over an entirety of the surface 1116b of the laminate structure 1140b. The layers 1141a, 1142a, and 1143a of the laminate structure 1140a and the layers 1141b, 1142b, and 1143b of the laminate structure 1140b may be formed of any of the weldable materials described with respect to FIGS. 1A and 1B, such as metal materials. In examples in which the laminate structure includes layers formed of nonweldable materials as well as layers formed of weldable materials, the welds may be formed only between adjacent layers formed of weldable materials and other techniques described herein may be used to couple other layers of the laminate structure.

The process for forming the laminate structures 1140a and 1140b may include several operations. After the layers of the laminate structure are assembled, a welding operation is used to form the welds. The welding operation may use a laser welding technique, a friction stir welding technique, or any other suitable welding technique. The parameters of the welding operation may be controlled to produce the desired weld size. In some embodiments, a machining operation and/or a finishing operation may be performed on one or more faces of the laminate structure after the welding operation. In some cases, a face of the laminate structure that defines an external surface of the enclosure may be co-machined so that the exterior faces of the layers are even with each other. After the co-machining process, the surface may be burnished. Alternately or additionally, the surface may be grit blasted. In some cases, an anodizing operation may form an oxide layer along one or more metal surfaces of the laminate structure. The anodizing operation is typically an electrochemical operation that forms an oxide layer along a metal surface and in some cases may selectively anodize layers of the laminate as previously described with respect to FIG. 9. In some examples, the oxide layer may be colored by introducing a dye into pores of the oxide layer.

FIGS. 12A, 12B, and 12C show additional examples of partial cross-sectional views of laminate structures that include a weld. In contrast to the examples of FIGS. 11A and 11B, the laminate structures of FIGS. 12A, 12B, 12C include features such as a tack weld, an adhesive, and an interlock pin, and the like in combination with a weld that extends inward from a surface of the laminate structure (e.g., 1216a, 1216b, and 1216c, respectively). The layers of the laminate structures 1240a, 1240b, and 1240c may be any of the layers described with respect to FIGS. 11A and 11B and that description is not repeated here. The number and configuration of the layers of the laminate structures shown in FIGS. 12A, 12B, and 12C is exemplary rather than limiting and in additional examples the laminate structure may include a different number of layers, different thicknesses of layers, and the like. The views of FIGS. 12A, 12B, and 12C may be examples of partial cross-sectional views of the housing 110 of FIG. 1B along A-A or examples of other housings described herein.

FIG. 12A shows a laminate structure 1240a that includes welds 1296 that extend inward from the surface 1216a and tack welds 1297 positioned inward from the welds 1296. In some cases, the tack welds 1297 may be created as the layers 1241a, 1242a, and 1243a are assembled. The operation of forming the tack welds may use any of the welding techniques described with respect to FIGS. 11A and 11B, or an electron beam welding technique. After the layers of the laminate structure 1240a are assembled, the welds 1296 may then be formed using the welding techniques described with respect to FIGS. 11A and 11B.

FIG. 12B shows a laminate structure 1240b that includes welds 1296 that extend inward from the surface 1216b and adhesive 1292 between the layers 1241b, 1242b, and 1243b of the laminate structure 1240b. The adhesive 1292 is positioned inward of the welds 1296. In the example of FIG. 12B, recesses 1253 are formed in the top surface of the layers 1242b and 1243b. The recesses 1253 may help to provide a space between the adhesive 1292 and the welds 1296 and thereby limit exposure of the adhesive 1292 to heat during the welding operation. After the layers of the laminate structure 1240b are assembled with the adhesive 1292, the welds 1296 may then be formed using the welding techniques described with respect to FIGS. 11A and 11B.

FIG. 12C shows a laminate structure 1240c that includes welds 1296 that extend inward from the surface 1216c and an interlock pin 1282. As shown in FIG. 12C, the layers of the laminate structure 1240c define a recess 1252 that extends through multiple layers of the laminate structure 1240c. In the example of FIG. 12C, the recess 1252 extends through the layers 1241c, 1242c, and 1243c. The interlock pin 1282 is positioned within the recess 1252 and helps prevent shear movement of the layers. The interlock pin 1282 may be similar in form, function, and composition to the interlock pin 1082 and that description is not repeated here. After the layers of the laminate structure 1240c are assembled with the interlock pin 1282, the welds 1296 may then be formed using the welding techniques described with respect to FIGS. 11A and 11B.

FIG. 13 shows an example of a partial cross-sectional view of a laminate structure that includes a diffusion bond. As shown in FIG. 13, the laminate structure 1340 includes layers 1341, 1342, and 1343, each of which define a portion of the side surface 1316. The diffusion bond 1398 is formed between the layers 1341 and 1342 and the diffusion bond 1399 is formed between the layers 1342 and 1343. The view of FIG. 13 may be an example partial cross-sectional view of the housing 110 of FIG. 1B along A-A or an example of another housing described herein.

In some embodiments, each of the layers 1341, 1342, and 1343 is a metallic layer. In some examples the metallic layers differ in composition. For example, one metallic layer may be formed of a titanium alloy and another metallic layer may be formed of an aluminum alloy. In additional examples, a diffusion bond may be formed between two ceramic layers, between ceramic and metal layers, or between glass and metal layers. In some cases, an interlayer may be used to facilitate diffusion bonding. For example, a layer of titanium or titanium alloy particles may be provided between layers of aluminum alloys to diffusion bond the aluminum alloy layers. If titanium alloy interlock pins are included in the laminate structure these pins may bond with the aluminum alloy layers and/or with the titanium-based interlayer (if present) during the diffusion bonding process. The diffusion bonding operation typically takes place at temperatures and pressures that are elevated above ambient temperature and pressure. In some examples, the diffusion bonding operation may be a hot isostatic pressure diffusion bonding (HIP-DB) operation. In some embodiments, the diffusion bonding operation may be preceded by a tack welding operation. The diffusion bonding operation may be followed by a machining operation and/or a finishing operation performed on one or more faces of the laminate structure. In some examples, one or more layers of the laminate structure may be anodized and optionally dyed in a similar fashion as previously described with respect to FIGS. 9 and 11.

FIG. 14 shows a block diagram of an example electronic device that may include a laminate component as described herein. The schematic representation depicted in FIG. 14 may correspond to components of the devices depicted in FIGS. 1A, 1B, and 6 through 8 as described above. However, FIG. 14 may also more generally represent other types of electronic devices including a laminate component as described herein.

In embodiments, an electronic device 1400 may include sensors 1420 to provide information regarding configuration and/or orientation of the electronic device in order to control the output of the display. For example, a portion of the display 1408 may be turned off, disabled, or put in a low energy state when all or part of the viewable area of the display 1408 is blocked or substantially obscured. As another example, the display 1408 may be adapted to rotate the display of graphical output based on changes in orientation of the device 1400 (e.g., 90 degrees or 180 degrees) in response to the device 1400 being rotated.

The electronic device 1400 also includes a processor 1406 operably connected with a computer-readable memory 1402. The processor 1406 may be operatively connected to the memory 1402 component via an electronic bus or bridge. The processor 1406 may be implemented as one or more computer processors or microcontrollers configured to perform operations in response to computer-readable instructions. The processor 1406 may include a central processing unit (CPU) of the device 1400. Additionally, and/or alternatively, the processor 1406 may include other electronic circuitry within the device 1400 including application specific integrated chips (ASIC) and other microcontroller devices. The processor 1406 may be configured to perform functionality described in the examples above.

The memory 1402 may include a variety of types of non-transitory computer-readable storage media, including, for example, read access memory (RAM), read-only memory (ROM), erasable programmable memory (e.g., EPROM and EEPROM), or flash memory. The memory 1402 is configured to store computer-readable instructions, sensor values, and other persistent software elements.

The electronic device 1400 may include control circuitry 1410. The control circuitry 1410 may be implemented in a single control unit and not necessarily as distinct electrical circuit elements. As used herein, “control unit” will be used synonymously with “control circuitry.” The control circuitry 1410 may receive signals from the processor 1406 or from other elements of the electronic device 1400.

As shown in FIG. 14, the electronic device 1400 includes a battery 1414 that is configured to provide electrical power to the components of the electronic device 1400. The battery 1414 may include one or more power storage cells that are linked together to provide an internal supply of electrical power. The battery 1414 may be operatively coupled to power management circuitry that is configured to provide appropriate voltage and power levels for individual components or groups of components within the electronic device 1400. The battery 1414, via power management circuitry, may be configured to receive power from an external source, such as an alternating current power outlet. In some examples, the battery may receive power via wireless charging. The battery 1414 may store received power so that the electronic device 1400 may operate without connection to an external power source for an extended period of time, which may range from several hours to several days.

In some embodiments, the electronic device 1400 includes one or more input devices 1418. The input device 1418 is a device that is configured to receive input from a user or the environment. The input device 1418 may include, for example, a push button, a touch-activated button, a capacitive touch sensor, a touch screen (e.g., a touch-sensitive display or a force-sensitive display), a capacitive touch button, dial, crown, or the like. In some embodiments, the input device 1418 may provide a dedicated or primary function, including, for example, a power button, volume buttons, home buttons, scroll wheels, and camera buttons.

The device 1400 may also include one or more sensors or sensor components 1420, such as a force sensor, a capacitive sensor, an accelerometer, a barometer, a gyroscope, a proximity sensor, a light sensor, or the like. In some cases, the device 1400 includes a sensor array (also referred to as a sensing array) which includes multiple sensors 1420. For example, a sensor array may include an ambient light sensor, a Lidar sensor, and a microphone. In additional examples, one or more camera components may also be associated with the sensor array. The sensors 1420 may be operably coupled to processing circuitry. In some embodiments, the sensors 1420 may detect deformation and/or changes in configuration of the electronic device and be operably coupled to processing circuitry that controls the display based on the sensor signals. In some implementations, output from the sensors 1420 is used to reconfigure the display output to correspond to an orientation or folded/unfolded configuration or state of the device. Example sensors 1420 for this purpose include accelerometers, gyroscopes, magnetometers, and other similar types of position/orientation sensing devices. In addition, the sensors 1420 may include a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device.

In some embodiments, the electronic device 1400 includes one or more output devices 1404 configured to provide output to a user. The output device 1404 may include a display 1408 that renders visual information generated by the processor 1406. The output device 1404 may also include one or more speakers to provide audio output. The output device 1404 may also include one or more haptic devices that are configured to produce a haptic or tactile output along an exterior surface of the device 1400.

The display 1408 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1408 is a liquid-crystal display or an electrophoretic ink display, the display 1408 may also include a backlight component that can be controlled to provide variable levels of display brightness. If the display 1408 is an organic light-emitting diode or an organic electroluminescent-type display, the brightness of the display 1408 may be controlled by modifying the electrical signals that are provided to display elements. In addition, information regarding configuration and/or orientation of the electronic device may be used to control the output of the display as described with respect to input devices 1418. In some cases, the display is integrated with a touch and/or force sensor in order to detect touches and/or forces applied along an exterior surface of the device 1400.

The electronic device 1400 may also include a communication port 1412 that is configured to transmit and/or receive signals or electrical communication from an external or separate device. The communication port 1412 may be configured to couple to an external device via a cable, adaptor, or other type of electrical connector. In some embodiments, the communication port 1412 may be used to couple the electronic device 1400 to a host computer. The electronic device may also include wireless communication circuitry. The wireless communication circuitry may be operably coupled to an antenna. The antenna may be internal to the enclosure or the enclosure may define at least a portion of the antenna.

The electronic device 1400 may also include at least one accessory 1416, such as a camera, a flash for the camera, or other such device. The camera may be part of a camera array or sensing array that may be connected to other parts of the electronic device 1400 such as the control circuitry 1410.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
an enclosure comprising:
a housing, at least a portion of the housing having a laminate structure comprising:
a first layer defining a front surface and a first portion of an exterior side surface of the housing;
a second layer defining a rear surface and a second portion of the exterior side surface of the housing; and
at least one intermediate layer positioned between the first layer and the second layer and defining a third portion of the exterior side surface of the housing; and
a cover member coupled to the housing and defining a transparent window; and
a touch-sensitive display positioned below the cover member and within a cavity defined at least in part by the housing and the cover member; and
electronic circuitry positioned within the cavity.

2. The electronic device of claim 1, wherein:
the at least one intermediate layer defines an opening; and
a device component is positioned within the opening.

3. The electronic device of claim 2, wherein the device component is an electronic component that is operably connected to the electronic circuitry.

4. The electronic device of claim 2, wherein:
each of the first layer and the second layer is formed from a metal;
the at least one intermediate layer is formed at least in part from a dielectric material; and
the dielectric material of the at least one intermediate layer at least partially defines the third portion of the exterior side surface of the housing.

5. The electronic device of claim 1, wherein:
the first layer and the at least one intermediate layer together define a side wall of the housing; and
the second layer defines a rear wall of the housing.

6. The electronic device of claim 1, wherein:
the enclosure is a first enclosure; and
the electronic device further comprises a second enclosure coupled to the first enclosure and a set of keys, a surface of the second enclosure defining a set of openings and each key of the set of keys extending into a respective opening of the set of openings.

7. The electronic device of claim 1, wherein the electronic circuitry comprises wireless communication circuitry.

8. An electronic device comprising:
electronic circuitry;
a display assembly; and
an enclosure at least partially surrounding the electronic circuitry and the display assembly and comprising:
a housing formed at least in part from a set of layers that define an exterior side surface of the housing, the set of layers comprising:
a first layer defining a front surface of the housing;
a second layer defining a rear surface of the housing; and
a set of intermediate layers positioned at least partially between the first layer and the second layer; and
a cover member at least partially defining a front surface of the electronic device, positioned over the display assembly, and coupled to the housing.

9. The electronic device of claim 8, wherein multiple layers of the set of intermediate layers protrude with respect to a portion of an interior surface of the housing that is defined by another layer of the set of layers.

10. The electronic device of claim 9, wherein the multiple layers of the set of intermediate layers define an attachment feature.

11. The electronic device of claim 9, wherein the multiple layers of the set of intermediate layers define a midplate of the housing.

12. The electronic device of claim 11, wherein each of the multiple layers of the set of intermediate layers define comprises:
a first portion formed from a metal material and defining a respective portion of the exterior side surface of the housing; and
a second portion formed from a material different than the metal material and defining a foldable region of the set of intermediate layers.

13. The electronic device of claim 8, wherein the set of intermediate layers defines the exterior side surface of the housing.

14. The electronic device of claim 8, wherein:
the cover member is a first cover member;
the display assembly comprises a touch sensor; and
the enclosure further comprises a second cover member coupled to the housing and at least partially defining a rear surface of the electronic device.

15. An electronic device comprising:
a first portion comprising:
a first enclosure defining an internal cavity and a transparent window; and
a display positioned within the first enclosure and below the transparent window; and
a second portion rotatably coupled to the first portion, defining an input surface, and comprising:
a second enclosure defining an exterior side surface and a rear surface of the electronic device, the second enclosure comprising:
a housing comprising:
a first metal layer defining a first portion of the exterior side surface;
a second metal layer defining a second portion of the exterior side surface; and
at least one intermediate layer positioned between and coupled to the first metal layer and the second metal layer and defining a third portion of the exterior side surface;
a front cover member coupled to the housing and defining a front surface of the second enclosure; and
a rear cover member coupled to the housing and defining a rear surface of the second enclosure; and
a touch sensor positioned within the second enclosure and configured to detect a touch along the input surface.

16. The electronic device of claim 15, wherein:
the at least one intermediate layer comprises a set of intermediate layers; and
at least one layer of the set of intermediate layers includes:
a first portion formed from a first material that partly defines the third portion of the exterior side surface; and
a second portion formed from a second material different than the first material.

17. The electronic device of claim 16, wherein:
the first metal layer, the second metal layer, and the first portion of the at least one layer of the set of intermediate layers together define a side wall of the housing; and
the first material has a higher Young's modulus than the second material.

18. The electronic device of claim 16, wherein:
the first material is a metal material; and
the second material is a composite material.

19. The electronic device of claim 18, wherein the first metal layer, the first portion of the at least one layer of the set of intermediate layers, and the second metal layer are joined at least in part by a weld.

20. The electronic device of claim 15, wherein the front cover member defines the input surface.
